(19) United States
(12) Patent Application Publication
(10) Pub. No.: US 2011/0084077 A1
(43) Pub. Date: Apr. 14, 2011

(54) A POLYMER BAG

(76) Inventors: Robert William James, Victoria (AU); Richard Ronald John Smith, Victoria (AU); Bohumil Havelka, Victoria (AU); Christopher avid King, Victoria (AU)

(21) Appl. No.: 12/161,407

(22) PCT Filed: Jan. 18, 2007
(86) PCT No.: PCT/AU2007/000049

§ 371 Date: Sep. 28, 2010

(30) Foreign Application Priority Data
Jan. 18, 2006 (AU) 2006900251

(51) Int. Cl. B65D 25/16; B65D 30/02; B65D 30/10; B31B 1/64; B31B 1/90

(52) U.S. Cl. 220/495.11; 383/201; 493/199; 493/212

(57) ABSTRACT

A bag (1) for storing perishable products such as fresh fruit and vegetables is disclosed. The bag is formed from a polymer film that has a film orientation direction and has an Elmendorf Tear Strength (ASTM D1922) in the range of 0.05 to 0.50 N in the film orientation direction. The bag comprises a bottom (8), an open top (10), a side wall comprising two wall sections (12,14) connected together by heat seals (2) extending between the top and the bottom of the bag. The bag is formed so that the film orientation direction of the film in the side wall is transverse to the heat seals. The bag also comprises a skirt (5) extending outwardly from each heat seal and at least one tear initiation notch (3) in at least one skirt.

The present invention relates to polymer bags for storing perishable products such as fresh fruit and vegetables and to a method of manufacturing such polymer bags.

In particular, the present invention relates to bags that are used to store fresh fruit and vegetables within rigid bulk containers that support the bags, for example rigid containers made from cardboard, corrugated board, metals, rigid plastics, timber and other materials. The rigid containers typically have a rectangular footprint and vertical sides, and hence the bags are required to form a shape with a rectangular footprint and vertical sides once placed inside the rigid containers.

In particular, the present invention relates to a polymeric bag in the form of a liner that, in use, is sealed to form an airtight bag which is used to retain a modified atmosphere within the bag and is positioned in an outer, more rigid, container. The term “bag” is understood herein to cover bags used in any application, including as a liner. Such bags are known in the art as “Modified Atmosphere Packaging”, or “MAP”. As an example, if the oxygen level is reduced and the carbon dioxide level is elevated in a bag compared to the oxygen and carbon dioxide levels in air, this will suppress respiration rate of fresh fruit or vegetables in the bag, which in turn will increase the shelf life of the produce before it loses product quality. Increasing the humidity level within a polymer liner bag can also help to increase the shelf life of the produce by slowing desiccation, and can be done independently of changing the oxygen or carbon dioxide levels in the bag.

The use of MAP allows for transportation of fresh fruit and vegetables over long distances from growing regions to intended markets. This enhances the ability of retailers to have extended marketing seasons for perishable fruit and vegetables. As an example, fresh cherries packaged in an appropriate liner can be stored and marketed for 8 weeks from harvest compared to 2 weeks in traditional packaging.

The bags are typically made from a polymer such as polyethylene (PE), low density polyethylene (LDPE), linear low density polyethylene (LLDPE) polypropylene (PP) or nylon (PA). Other suitable polymers can be used. Polymers with the desired transmission of moisture, oxygen and carbon dioxide for particular applications are rare and expensive or unavailable. It is desirable to manufacture liners for MAP from commodity polymers, and further to limit the range of polymer films used for the manufacture of MAP liners.

The desired process of selection of a MAP liner is to select a polymer with a desired intrinsic resistance to moisture transmission. Where a polymer that is selected on the basis of moisture transmission properties has insufficient transmission of oxygen and carbon dioxide, the transmission of oxygen and carbon dioxide can be increased by micro-perforation. It is known that micro-perforation has minimal effect on total moisture transmission.

As the bags of the present invention are intended to be used as packaging for “commodity” whole fresh fruit and vegetables, the bags should preferably be made from an inexpensive film that can be readily folded and heat-sealed into a robust and large box liner. Multi-layer laminates and co-extruded films containing specialised polymers are most likely too expensive.

In addition, the inexpensive film must also have specific gas permeability requirements, primarily for oxygen, carbon dioxide and moisture to be used as a MAP liner.

The films used to fabricate the bags are typically manufactured by either blown or cast extrusion methods.

In a blown film extrusion method, molten polymer is blown into a continuous bubble, which is then flattened into a tube, which can be cut or sealed at desired intervals along the length of the tube. During the blowing of the film the film is typically elongated in both the machine (or manufacturing) and transverse directions. This elongation is important because it changes the mechanical properties of the film. In particular, if the film tends to be elongated more in the machine direction than the transverse direction, this creates asymmetrical mechanical properties, with the film having higher tensile properties and lower tear properties in the machine direction. In practice this means that the bag is easier to tear in the machine direction.

In the cast method, molten polymer is extruded into a film via a die. Only the machine direction of the film created in this manner is elongated, which tends to lead to greater asymmetry of tensile and tear properties than seen with the blown film method.

MAP liners have been used for fresh fruit and vegetable packaging for around ten years. They have been well accepted in the market place. Retailers now are regularly using the rigid container in which the fresh fruit and vegetables are supplied as the display unit for sale of the contained produce. As a result, retailers require the top surface of the MAP liner to be removed from the rigid container just prior to displaying the produce. This has created a known problem with the existing art in that it can be difficult to open the bags and/or to remove the top surface of the bags prior to displaying the produce by the retailers.

An obvious solution of tearing out the top surface of a bag is problematic because of the difficulties making straight tear lines around virtually right-angle corners and across loose creases in the bag caused by gathering the neck of the bag to the centre of the top surface for sealing.

Due to the size of the bags, it is often not possible to easily reach the inside of all of a bag when tearing the bag. Hence, to tear out the top surface of a bag means propagating tears along two separate sides of the bag, which can be separated by up to 30 cm or more. Up to now this has been proven to be quite difficult to achieve in practice.

One known solution is to open a bag and empty all of the produce out of the bag back into the rigid container. This requires additional labour, and the extra handling can damage the fruit and vegetables.

Another known solution is for a staff member in a retailer to either cut or try to tear out the top surface of a bag when it is time to display the produce. This can involve the use of knives, which adds a safety risk. Without a knife the bags can be difficult to tear, and the inevitable uneven tear lines of the bag may not be what the retailer desires, which may lower the attractiveness of the displayed produce.

Another known solution is to assist the tearing by perforating a bag with a series of small nicks or tears along a desired tear line. Whilst leading to a neat and well controlled tear, a weakness with this solution is that the nicks or tears may puncture the bag, leading to a loss of the desired modified atmosphere and a significant reduction in the shelf life of the contained produce.

Another solution known in the art is to assist the retailer to open the bag by adding a notch in a side seal of the bag. Such bags are typically formed with the main orientation (top to bottom of the bag) lying along the transverse direction of the film. This assists the tearing of the bag, which is more likely to run across the bag (the manufacturing or machine direction of the film) for the reasons discussed above. These bags then need to be sealed at the side with a heat seal, also known as a pouch seal.

One weakness of the notch solution is that notches are formed in the side seals of bags. A side effect of the heat sealing process is that the sealed edge is slightly shorter than the rest of the bag, due to contraction from the heat sealing process. Being slightly shorter than the rest of the bag means that it will bear more of the stress if the bag is pulled, as can happen during ordinary handling. If a notch is added to the sealed edge to assist tearing, there is a risk that increased stress borne by the side seal as a consequence of the notch will result in the bag tearing inadvertently due to normal handling stress. In this situation the bag will open and the modified atmosphere will be lost, greatly reducing the shelf life of the produce.

A second weakness of the notch solution is that tearing the bag may not be as neat or well controlled as desirable for the presentation of the torn bag.

The above description is not to be taken to be an admission of the common general knowledge.

The present invention provides an easy open polymer bag for perishable products such as bulk fresh fruit and vegetable produce that does not have the difficulties discussed above or substantially alleviates at least some of the difficulties.

According to the present invention there is provided a bag for storing perishable products such as fresh fruit and vegetables, which bag is formed from a polymer film that has a film orientation direction as described herein and has an Elmendorf Tear Strength (ASTM D1922) in the range of 0.05 to 0.50 N in the film orientation direction, and which bag comprises a bottom, an open top, a side wall comprising two wall sections connected together by heat seals extending between the top and the bottom of the bag, with the bag being formed so that the film orientation direction of the film in the side wall is transverse to the heat seals, a skirt extending outwardly from each heat seal, and at least one tear initiation notch in at least one skirt.

The above-described combination of a polymer bag (a) being made from a polymer film having a tear strength in the film orientation direction within the stated range and (b) having a particular construction, as described above, provides a polymer bag that does not tear as a consequence of standard handling and can be opened by a retailer with a controlled tearing action that forms an opening that is presentable in a retail setting.

The term “film orientation direction” is understood herein to mean that the molecules of the polymer of the polymer film are not completely randomly arranged and are preferentially oriented to a certain extent in a given direction. The orientation may be the result of processing a molten polymer in such a way, for example by extrusion, that orients the polymer in a given direction. Alternatively, or in addition, the orientation may be the result of processing of a film that has been formed.

Preferably the tear initiation notch is located either entirely or mostly within the skirt.

Preferably the skirt is shielded from normal handling stresses by the heat seal and, consequently, the tear initiation notch within the side skirt is much less likely to be the start of unwanted tearing within the bag.

Preferably the width of the skirt is between 2 to 25 mm.

More preferably the width of the skirt is between 10 to 15 mm.

The tear initiation notch may have a variety of shapes that include but is not limited to a simple cut, a V shape, a series of notches of any type separated regularly along the skirt to create multiple optional tear initiation points, and a series of notches of any type adjacent to each other and forming a serrated shape of V's or other notches known in the art.

Preferably the length of the tear initiation notch is greater than 25% of the width of the skirt.

More preferably the length of the tear initiation notch is greater than 50% of the width of the skirt.

In one embodiment the tear initiation notch is distinctly clear of the heat seal.

In another embodiment the tear initiation notch ends adjacent the heat seal.

In another embodiment the tear initiation notch ends within the heat seal, although the beginning of the notch (the open end of the notch) is within the skirt.

In another embodiment the skirt is reinforced at the position of the tear initiation notch, for example by the addition of extra material near the notch, or by local widening of the heat sealed area near the notch.

Preferably the bag includes more than one tear initiation notch to give a retailer or other user the flexibility to easily open the bag at different positions.

Preferably both skirts of the bag comprise at least one tear initiation notch.

Preferably the bag acts as a modified atmosphere package.

By way of example in this regard, optionally the bag includes micro-perforations to change the relative barrier properties of oxygen and carbon dioxide as desired.

The applicant has found that the above-described range of Elmendorf Tear Strength (ASTM D1922) of 0.05 to 0.50 N provides the bag with tear properties that allow the bag to cleanly tear in a straight line across the bag. In particular, the polymers, films and conditions are selected to find an appropriate balance between ease of tearing and sufficient resistance to splitting.

Preferably the Elmendorf Tear Strength (ASTM D1922) is at least 0.05 in the film orientation direction of the film.

It is preferred particularly that the Elmendorf Tear Strength (ASTM D1922) be in the range of 0.05 to 0.20 N in the film orientation direction of the film.

Preferably the Elmendorf Tear Strength (ASTM D1922) is less than 0.18 N in the film orientation direction of the film.

It is preferred particularly that the Elmendorf Tear Strength (ASTM D1922) be in the range of 0.08 to 0.18N in the film orientation direction of the film.

In one embodiment the film comprises one polymer.

Preferably the polymer is a polypropylene.

In another embodiment the film comprises a blend of two or more than two polymers. Each polymer may be a homopolymer or a co-polymer.

Preferably the blend is a blend of a polypropylene and a polyethylene.

More preferably the blend is a blend of a polypropylene and a polyethylene that can be extruded as a blown film.

Preferably the blend of the polypropylene and the polyethylene comprises less than 40% by weight polyethylene.

More preferably the blend of the polypropylene and the polyethylene comprises less than 30% by weight polyethylene.

Preferably the blend of the polypropylene and the polyethylene comprises at least 10% by weight polyethylene.

According to the present invention there is also provided a container for storing perishable products such as fresh fruit and vegetables that comprises an outer rigid body and an inner flexible liner made from the above-described polymer bag.

The term “rigid” as used herein is understood to mean that the outer body is constructed to be able to survive standard handling required to fill the container and thereafter store and transport the container to a retail outlet.

According to the present invention there is also provided a container that stores perishable products such as fresh fruit and vegetables that comprises an outer rigid body and an inner flexible liner made from the above-described polymer bag and the products sealed in the bag.

According to the present invention there is also provided a method of manufacturing a bag for storing perishable products such as fresh fruit and vegetables that comprises the steps of (a) forming a folded sheet of a polymer film having a film orientation direction in a lengthwise extending direction of the film and an Elmendorf Tear Strength (ASTM D1922) in the range of 0.05 to 0.50 N in the film orientation direction, with the folded sheet having an upper layer and a lower layer folded around a fold line, (b) heat sealing together two sections of the upper and lower layers of the folded sheet and forming two parallel, spaced apart heat seals transversely, preferably perpendicular, to the film orientation direction of the film, (c) cutting the tube parallel to and outboard of the heat seals and thereby forming skirts extending outwardly from the heat seals, and (d) forming at least one tear initiation notch in at least one of the skirts.

The folded sheet of the polymer film may be made by any suitable method step or steps.

By way of example, the folded sheet of the polymer film may be made by forming a flattened tube of the polymer film having a film orientation direction in a lengthwise extending direction of the film and thereafter slitting the tube along one lengthwise extending side of the flattened tube, i.e. along the film orientation direction of the film.

The tube of the polymer film may be formed by any suitable method.

For example, the polymer film tube may be a blown film.

By way of example, the folded sheet of the polymer film may be made by folding a cast film sheet.

A range of polymers for the polymer film for the bag was considered by the applicant and assessed in an extensive series of experiments.

The range included low density polyethylene (LDPE), linear low density polyethylene (LLDPE), high density polyethylene HDPE, polypropylene (PP), and nylon.

LDPE and LLDPE based films were discounted because tear initiation and propagation of these films is difficult and uncontrollable.

Nylon was considered and then eliminated. Immediately after extrusion it has very low MD tear resistance, but with time nylon absorbs moisture thereby increasing its tear resistance. The variable nature of this absorption was not conducive to controllable tear.

A review of previously manufactured HDPE/LLDPE blends indicated the tear properties were not ideal.

Previous work on PP based films indicated this was the most likely material to provide the required tear properties.

During the course of experiments on the range of polymer films the applicant concluded that the tear strength target for the polymer film should be between 0.05 TO 0.50 N, preferably 0.05N and 0.20 N, and more preferably between 0.08 N and 0.18 N, in order to provide controlled tear characteristics.

In particular, the applicant observed in the experiments that if the tear strength was too low the direction of tear would be uncontrolled, in a similar way for example that a potato chip packet is known to tear. A controllable tear direction is important for a number of reasons, including that the orientation of the bag is not always in the horizontal direction of the rigid container, hence it is desirable to be able to tear in other directions apart from directly across the bag.

It was also observed by the applicant that if the tear strength was too high the bag would start to stretch rather than tear at the tip of the notch. This would also lead to uncontrolled tear due the elastic energy building up in the area of the bag being stretched, as well as making the bag physically harder to tear. This is particularly important when the tear is propagated through the heat seal of the bag, which is the hardest part of the bag to tear.

A useful analogy for the desired tearing behaviour is that exhibited by a paper bag made from brown kraft paper, which has desirable tear properties, including the controllability of the tearing.

The present invention is described further by way of example with reference to the following drawings of which:

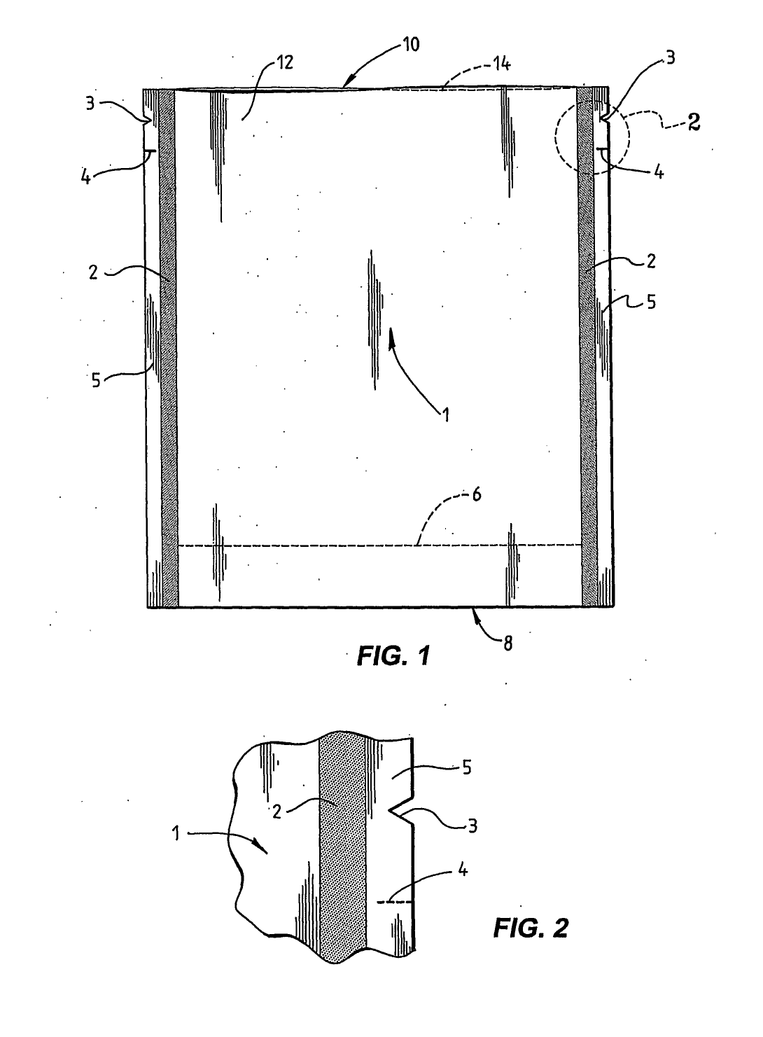

FIG. 1 is a plan view of one embodiment of a polymer bag in accordance with the present invention in an as-manufactured configuration;

FIG. 2 shows a detail of the side of the bag shown in FIG. 1;

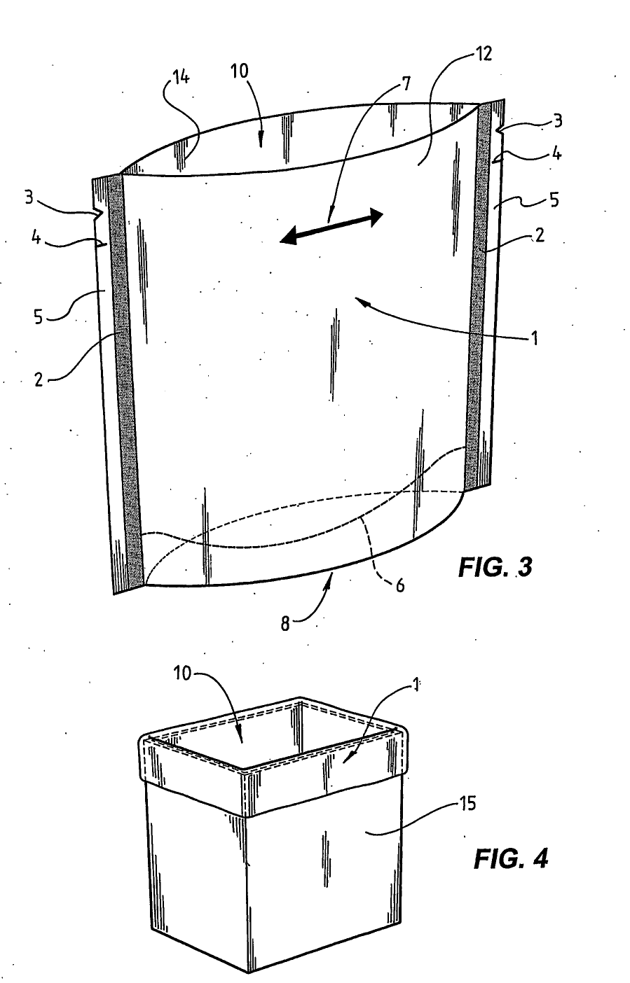

FIG. 3 shows the bag after it has been opened and is in the process of being manipulated into an operative position; and

FIG. 4 shows the bag in use in an operative position inside a comparatively rigid container, such as a cardboard box, ready for filling with produce.

The embodiment of the bag, generally identified by the numeral 1 shown in the Figures, is described in the context of a bag that is used as a flexible liner in a rigid container such as a cardboard box for transporting perishable products such as fresh fruit and vegetables. The bag 1 is described particularly in the context of the resultant container being used as the means for storing the products in a retail setting. Typically, for this application, the cardboard box has a footprint of at least 40 cm×30 cm and the bag 1 is sized to fit into boxes of such a size.

It is noted that the bag 1 is not confined to this application and the bag may be manufactured in smaller sizes to suit (a) other applications and (b) particular applications in the fresh produce market that require smaller sized boxes.

In the as-manufactured form shown in FIG. 1, with the polymer bag 1 in a flattened form, the polymer bag 1 includes a closed bottom 8, an open top 10, a front wall section 12, a back wall section which is immediately behind the front wall section 12 as viewed in FIG. 1 and is identified by the numeral 14 in FIG. 3, sides defined by heat seals 2 that connect together the front and back wall sections 12, 14 and extend between the bottom 8 and the top 10, and side skirts 5 that extend outwardly from the heat seals 2.

The bag 1 is formed so that the film orientation direction of the polymer film in the side wall is transverse to the heat seals 2, i.e. extends across the side of the bag.

In an open operative form of the bag 1, for example as shown in FIG. 3, the front and back wall sections 12, 14 define the side wall of the bag 1 and the skirts 5 extend outwardly from the side wall.

The bag 1 includes a gusset 6 in the bottom of the bag to help the bag expand its volume to form a square base in an open operative configuration.

The bag 1 also includes a tear initiation notch 3 in each skirt 5.

The bag 1 is made, by way of example, from a blown film tube by (a) slitting the tube, when in a flattened configuration, along one lengthwise extending side of the tube, i.e. along the film orientation direction of the film, (b) heat sealing together two sections of the front and back wall sections 12, 14 of the flattened tube and forming two parallel, spaced apart heat seals 2 transversely, preferably perpendicular, to the film orientation direction of the film and forming the side wall of the bag, (c) cutting the tube parallel to and outboard of the heat seals 2 and forming skirts 5 extending outwardly of the heat seals 2, and (d) forming tear initiation notches 3, 4 in the skirts 5.

FIG. 2 shows a detail of the right side of the bag 1. The Figure shows the bag 1, the heat seal 2, the side skirt 5, a v-notch tear initiator 3, and a line notch tear initiator 4.

FIG. 3 shows the bag 1 in an expanded form, i.e. in an open operative position, with an arrow 7 showing the film orientation direction of the polymer film of the bag. As is described in more detail below, the open end 10 of the bag is normally closed with either a simple cable tie or clip after filling, although it is possible to heat seal the top of the bag or use other closing means.

FIG. 4 shows the open bag 1 used in an open operative position as a liner-inside a comparatively rigid container 8 in the form of a cardboard box ready for filling with perishable products, such as fresh fruit and vegetables. After the open bag 1 is filled with produce, the open end 10 of the bag is closed, for example by suitable cable ties or clips or by heat sealing, and a lid (not shown) is placed on the box. Thereafter, the box is transported to a retail outlet, such as a fruit and vegetable section of a supermarket. The lid is removed from the box. Thereafter, the closed bag is opened by a retailer initiating a tear in one of the tear initiation notches 3 and controlling the propagation of the tear until the closed upper end section of the bag is separated from the remainder of the bag. On the basis of the experiments of the applicant, the selection of the polymer film to have an Elmendorf Tear Strength (ASTM D1922) in the range of 0.05 to 0.50 N, preferably 0.05 to 0.20 N, and more preferably 0.08 to 0.18 N in the film orientation direction of the film means that the tear can be controlled so that the resultant torn edge is straight and well-formed. Moreover, the construction of the bag so that the tear initiation notches 3 are positioned in skirts 5 that extend outwardly from the side wall of the bag and the film orientation direction extends perpendicular to the side wall means that the tear will propagate preferentially in the film orientation direction across the bag at the height of the selected notch on the bag. In addition, forming the bag with heat seals 2 that connect together front and back mall sections 12, 14 and positioning the tear initiation notches 3 outboard of the heat seals 2 means that there is a low possibility of accidental tear initiation and propagation during standard handling of the bag. Once formed, the torn edges of the opened bag can be pushed down inside the container, thereby forming a presentable produce holder that can be used as part of a retail display. Moreover, significantly, the bag 1 makes it possible to pack produce, transport the packaged produce, and open the packaged produce and display it for purchase in a retail location without the produce being handled.

Many modifications may be added to the embodiment of the bag described above in relation to the drawings without departing from the spirit and scope of the invention.

1. A bag for storing perishable products such as fresh fruit and vegetables, which bag is formed from a polymer film that has a film orientation direction as defined herein and has an Elmendorf Tear Strength (ASTM D1922) in the range of 0.05 to 0.50 N in the film orientation direction, and which bag comprises a bottom, an open top, a side wall comprising two wall sections connected together by heat seals extending between the top and the bottom of the bag, with the bag being formed so that the film orientation direction of the film in the side wall is transverse to the heat seals, a skirt extending outwardly from each heat seal, and at least one tear initiation notch in at least one skirt.

2. The bag defined in claim 1 wherein the tear initiation notch is located either entirely or mostly within the skirt.

3. The bag defined in claim 2 wherein the skirt is shielded from normal handling stresses by the heat seal and, consequently, the tear initiation notch within the skirt is much less likely to be the start of unwanted tearing within the bag.

4. The bag defined in claim 2 or claim 3 wherein the width of the skirt is between 2 to 25 mm.

5. The bag defined in claim 1 wherein the length of the tear initiation notch is greater than 25% of the width of the skirt.

6. The bag defined in claim 1 wherein the skirt is reinforced at the position of the tear initiation notch.

7. The bag defined in claim 1 includes more than one tear initiation notch to give a retailer or other user the flexibility to easily open the bag at different positions.

8. The bag defined in claim 1 wherein the Elmendorf Tear Strength (ASTM D1922) is in the range of 0.05 to 0.20 N in the film orientation direction of the film.

9. The bag defined in claim 1 wherein the Elmendorf Tear Strength (ASTM D1922) is at least 0.5 N in the film orientation direction of the film.

10. The bag defined in claim 1 wherein the Elmendorf Tear Strength (ASTM D1922) is in the range of 0.08 to 0.18 N in the film orientation direction of the film.

11. The bag defined in claim 1 wherein the Elmendorf Tear Strength (ASTM D1922) is less than 0.18 N in the film orientation direction of the film.

12. The bag defined in claim 1 wherein film comprises a blend of two or more than two polymers.

13. The bag defined in claim 12 wherein the blend is a blend of a polypropylene and a polyethylene.

14. The bag defined in claim 13 wherein the blend of the polypropylene and the polyethylene comprises less than 40% by weight polyethylene.

15. A container for storing perishable products such as fresh fruit and vegetables that comprises an outer rigid body and an inner flexible liner made from the polymer bag defined in claim 1.

16. A container that stores perishable products such as fresh fruit and vegetables that comprises an outer rigid body and an inner flexible liner made from the polymer bag defined in claim 1 and the products sealed in the bag.

17. A method of manufacturing a bag for storing perishable products such as fresh fruit and vegetables that comprises the steps of by (a) forming a folded sheet of a polymer film having a film orientation direction in a lengthwise extending direction of the film and an Elmendorf Tear Strength (ASTM D1922) in the range of 0.05 to 0.50 N in the film orientation direction, with the folded sheet having an upper layer and a lower layer, (b) heat sealing together two sections of the upper and lower layers of the folded sheet and forming two parallel, spaced apart heat seals transversely, preferably perpendicular, to the film orientation direction of the film, (c) cutting the tube parallel to and outboard of the heat seals and thereby forming skirts extending outwardly from the heat seals, and (d) forming at least one tear initiation notch in at least one of the skirts.
